(19) United States
(12) Patent Application Publication
(10) Pub. No.: US 2005/0094814 A1
(43) Pub. Date: May 5, 2005

(54) Electronic apparatus and encryption key updating

(76) Inventor: Tadahiro Aihara, Hachioji-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/975,080

(22) Filed: Oct. 28, 2004

(30) Foreign Application Priority Data
Oct. 31, 2003 (JP) 2003-372991

(51) Int. Cl. H04K 1/00

(52) U.S. Cl. 380/247

(57) ABSTRACT

After an encryption key creating unit creates/updates an encryption key, an encryption key update timing control unit monitors whether or not the elapsed time since this time has reached the shortest holding time or longest holding time. If the shortest holding time has elapsed, the encryption key update timing control unit monitors whether or not wireless communication is being executed by a wireless unit. If a state wherein no wireless communication is being executed is detected, the encryption key creating unit is caused to create/update an encryption key at this timing. When the longest holding time has elapsed while this state is not detected, the encryption key update timing control unit gives a wireless unit an instruction to temporarily interrupt the wireless communication, and causes the encryption key creating unit to create/update an encryption key during interruption of wireless communication.

### CROSS-REFERENCE TO RELATED APPLICATIONS

This application is based upon and claims the benefit of priority from prior Japanese Patent Application No. 2003-372991, filed Oct. 31, 2003, the entire contents of which are incorporated herein by reference.

### BACKGROUND OF THE INVENTION

1. Field of the Invention

The present invention relates to a cryptographic technique used when data communication is performed in an electronic apparatus such as a personal computer or access point.

2. Description of the Related Art

With the recent advances in wireless communication techniques, wireless LANs (Local Area Networks) have begun to proliferate in office environments and the like in place of connection between electronic apparatuses through cables. In this wireless LAN, since data is transmitted/received through a wireless communication channel, encryption is generally performed by using WEP (Wired Equivalent Privacy) or the like to provide security against data leakage.

WEP is an encryption system which encrypts data by using a fixed encryption key. Recently, however, a great deal of attention has been paid to encryption systems such as TKIP (Temporal Key Integrity Protocol), WRAP (Wireless Robust Authenticated Protocol), and CCMP (Counter Mode/CBC MAC protocol), which allow updating of encryption keys to realize a safer security function. TKIP, WRAP, and CCMP are planned to be used in WPA (Wi Fi Protected Access) and IEEE802.11i which have recently been developed. WPA and IEEE802.11i define mechanisms for arbitrarily updating encryption keys used in these encryption systems.

Under the circumstances, various techniques of updating encryption keys at proper timings have been proposed (see, for example, U.S. Pat. No. 5,708,711). According to the technique disclosed in the specification of U.S. Pat. No. 5,708,711, one day is divided into time intervals, e.g., “morning”, “afternoon”, “evening”, and “overnight”, and a data communication state is analyzed for each time interval to determine the update timing of an encryption key. This makes it possible to decrease the probability that update processing of an encryption key will affect data communication processing.

The technique disclosed in U.S. Pat. No. 5,708,711 is strictly designed to perform statistical estimation, but gives no consideration to whether an encryption key is actually updated at a proper timing. For example, a wireless LAN has a high throughput; 11 Mbps in IEEE802.11b and 54 Mbps in IEEE802.11a and IEEE802.11g, and hence is used not only as a means for simple data communication but also as a means for transmitting TV signals, video data, and the like that demand real time responsiveness. In transferring data that demand such real time responsiveness, when an encryption key is updated during transfer, a picture or sound is expected to be interrupted, thus considerably impairing its usability. As described above, the selection of an encryption key updating timing is very important.

### BRIEF SUMMARY OF THE INVENTION

According to an embodiment of the present invention, an electronic apparatus comprises a data communication unit; an encryption key creating unit configured to create an encryption key used for encryption of data to be transmitted by the data communication unit; a monitoring unit configured to monitor a data communication state of the data communication unit; a time calculating unit configured to calculate an elapsed time since an encryption key is created by the encryption key creating unit; and an encryption key updating control unit configured to cause the encryption key creating unit to create a new encryption key at a timing at which a state in which no data communication is being executed is detected by the monitoring unit after the elapsed time calculated by the time calculating unit reaches a predetermined shortest holding time.

According to another embodiment of the present invention, an electronic apparatus comprises a data communication unit; an encryption key creating unit configured to create an encryption key used for encryption of data to be transmitted by the data communication unit; a monitoring unit configured to monitor a data communication state of the data communication unit; a first time calculating unit configured to calculate an elapsed time of a state in which after an end of data communication is detected by the monitoring unit, a start of next data communication is not detected; and an encryption key updating control unit configured to cause the encryption key creating unit to create a new encryption key at a timing at which the start of data communication is detected by the monitoring unit after the elapsed time calculated by the first time calculating unit has reached a predetermined reference interval time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the connection form of a wireless LAN communication system according to the first embodiment of the present invention;

FIG. 2 is a block diagram showing the arrangement of a personal computer according to the first embodiment;

FIG. 3 is a chart for explaining the encryption key update timing selection principle of an encryption key update timing control unit in the first embodiment;

FIG. 4 is a flowchart showing the flow of processing up to the creation of the first encryption key by a personal computer of the first embodiment through association/authentication with an access point;

FIG. 5 is a flowchart showing the flow of encryption key update timing control performed by the personal computer in the first embodiment;

FIGS. 6A and 6B are charts for explaining the encryption key update timing of an encryption key update timing control unit in the second embodiment; and

FIG. 7 is a flowchart showing the flow of encryption key update timing control performed by the personal computer in the second embodiment.

### DETAILED DESCRIPTION OF THE INVENTION

The embodiments of the present invention will be described with reference to the views of the accompanying drawing.

(First Embodiment)

The first embodiment of the present invention will be described first.

FIG. 1 shows the connection form of a wireless LAN communication system according to the first embodiment of the present invention. A personal computer 1 is an information processing apparatus as of a notebook type equipped with a wireless communication function. The personal computer 1 is connected to a network 3 through an access point 2, as needed. Various information processing apparatuses such as another personal computer are connected to the network 3, and an external network is further connected to it. The personal computer 1 can transmit/receive data to/from them.

The access point 2 is a relay apparatus which relays between the personal computer 1 and the network 3. The access point 2 forms a wireless service area for a wireless LAN 4 aimed at the personal computer 1, and is accommodated in the network 3 through a wired LAN cable 5. That is, the personal computer 1 and access point 2 are electronic apparatuses which wirelessly transmit/receive data, and both have functions of encrypting data by using encryption keys when transmitting the data. The wireless LAN communication system of the first embodiment is characterized in that the personal computer 1 and access point 2 can update encryption keys at proper timings. This point will be described in detail below. Note that the following description will be focused on the personal computer 1, assuming that the personal computer 1 takes the initiative to control updating of an encryption key.

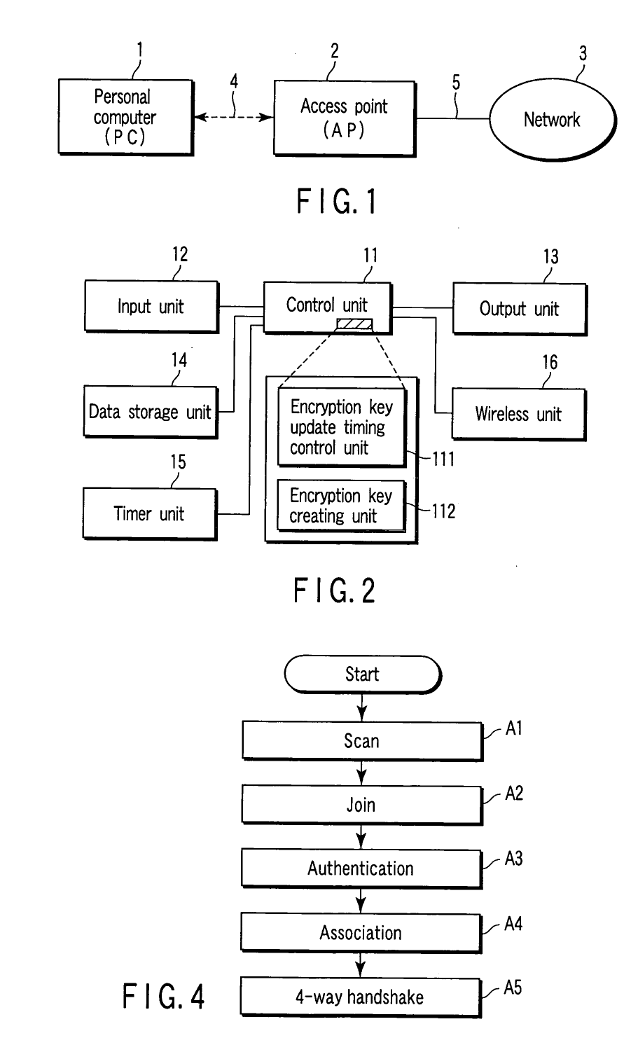

FIG. 2 is a block diagram showing the arrangement of the personal computer 1. As shown in FIG. 2, the personal computer 1 includes a control unit 11, input unit 12, output unit 13, data storage unit 14, timer unit 15, and wireless unit 16.

The control unit 11 performs various control operations of the personal computer 1 and includes an encryption key update timing control unit 111 and encryption key creating unit 112 (to be described later). The input unit 12 inputs various kinds of information and operation instructions through, for example, a keyboard and mouse. The output unit 13 outputs various kinds of information through, for example, a display and loudspeakers. The data storage unit 14 is a memory device such as an EEPROM or HDD in which various kinds of data are stored. The timer unit 15 is a timer module which includes, for example, its own power supply and counts the system time used by the personal computer 1. The wireless unit 16 executes wireless communication complying with, for example, the IEEE802.11i protocol.

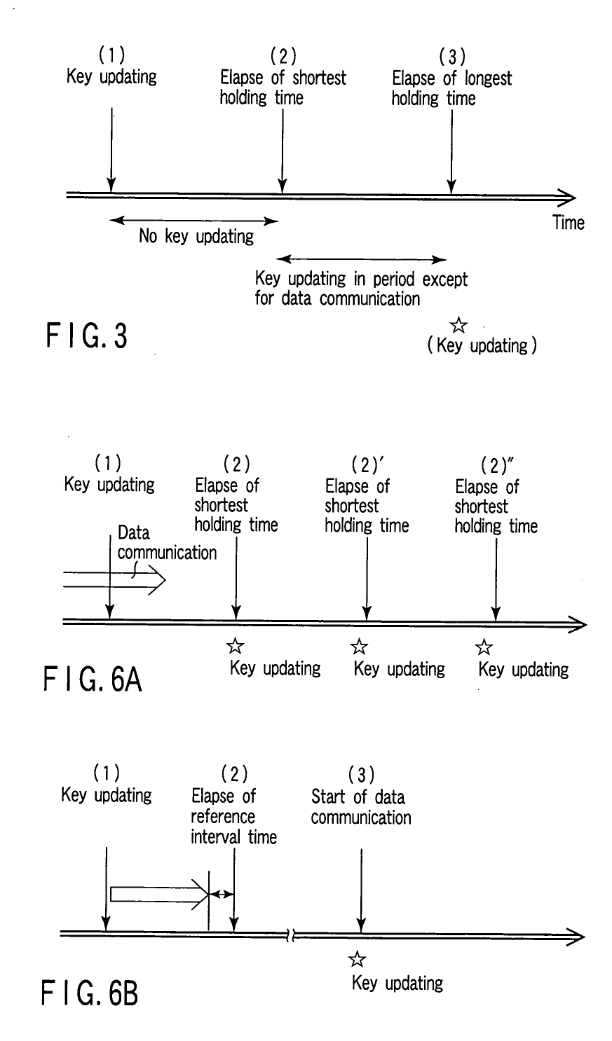

As described above, the personal computer 1 wirelessly transmits/receives data to/from the access point 2, and takes the initiative to update an encryption key for encrypting transmission data. The encryption key update timing control unit 111 controls the update timing of the encryption key. The encryption key creating-unit 112 creates/updates an encryption key in synchronism with the access point 2 as a communication partner. The principle on which the encryption key update timing control unit 111 selects an encryption key update timing will be described with reference to FIG. 3.

When the encryption key creating unit 112 creates/updates an encryption key ((1) in FIG. 3), the encryption key update timing control unit 111 acquires the corresponding time from the timer unit 15. The encryption key update timing control unit 111 has acquired the shortest holding time data and longest holding time data stored in the data storage unit 14, and subsequently monitors whether or not the elapsed time since the creation/updating of this encryption key has reached the shortest holding time or longest holding time.

A pair of the shortest holding time and the longest holding time define the allowable range of an encryption key update interval. The shortest holding time is set to prevent unnecessary updating of an encryption key. The longest holding time is set to ensure safety. These times are set by a user through the GUI provided by the control unit 11 or the like and stored in the data storage unit 14.

The encryption key update timing control unit 111 therefore inhibits the encryption key creating unit 112 from creating/updating an encryption key until the shortest holding time has elapsed since the previous creation/updating of an encryption key ((2) in FIG. 3). When this shortest holding time has elapsed, the encryption key update timing control unit 111 monitors whether or not wireless communication is executed by the wireless unit 16. Upon detecting a state wherein no wireless communication is executed, the encryption key update timing control unit 111 causes the encryption key creating unit 112 to create/update an encryption key at this timing. This prevents the update processing of the encryption key from affecting data communication processing.

Assume that the elapsed time since the previous creation/updating of an encryption key has reached the longest holding time ((3) in FIG. 3) while a state wherein no wireless communication is executed is not detected, i.e., the timing for the creation/updating of an encryption key is not obtained. In this case, the encryption key update timing control unit 111 instructs the wireless unit 16 to temporarily interrupt the wireless communication at this timing, and causes the encryption key creating unit 112 to create/update the encryption key. This makes it possible to ensure the safety of wireless data communication.

In this manner, the encryption key update timing control unit 111 realizes encryption key updating at a proper timing in consideration of the balance between efficiency and safety.

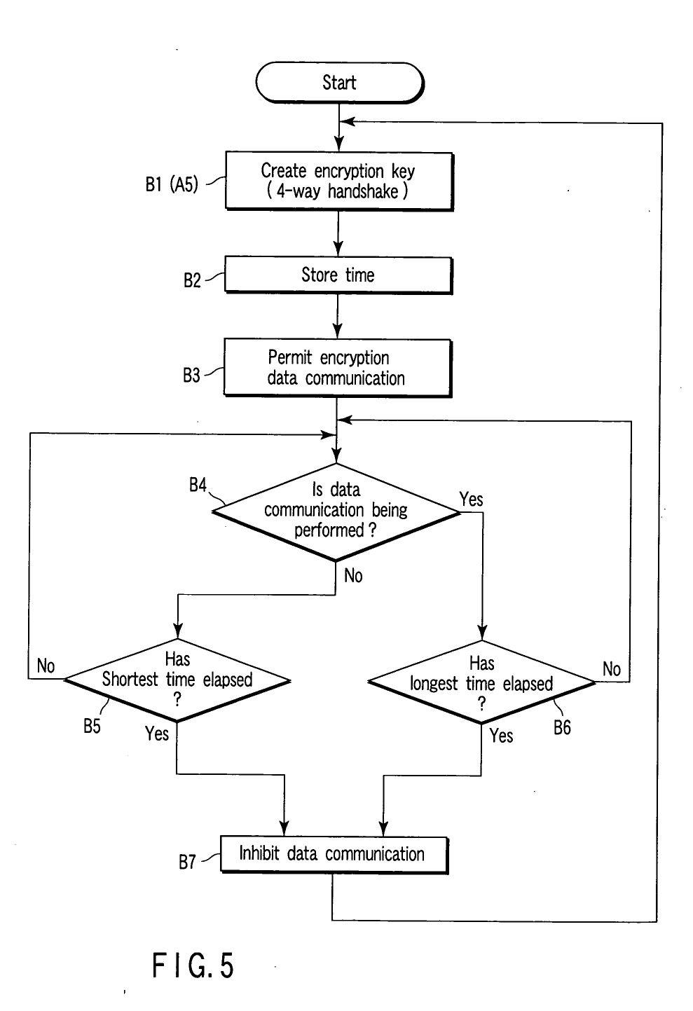

An operation sequence for encryption key updating control which is executed by the personal computer 1 will be described next with reference to FIGS. 4 and 5.

The flow of processing up to the creation of the first encryption key by the personal computer 1 through association/authentication with the access point 2 will be described first with reference to FIG. 4.

First of all, the control unit 11 executes scanning to check whether or not the access point 2 is present nearby (step A1). If it is determined that the access point 2 is present nearby, the control unit 11 joins the access point 2 and synchronizes with the access point 2 (step A2).

Upon establishing the synchronization, the control unit 11 executes authentication (step A3). The authentication in this case is called open system authentication; when the personal computer 1 gives an authentication request, the access point 2 directly receives the authentication request without performing any special authentication processing.

The control unit 11 then performs association with the access point 2 (step A4). When this association is complete, the encryption key creating unit 112 executes encryption key creation called 4 way handshake (and group key handshake) together with the access point 2 (step A5).

FIG. 5 is a flowchart showing the flow of encryption key update timing control performed by the personal computer 1.

Upon causing the encryption key creating unit 112 to create an encryption key by the above 4 way handshake (and group key handshake), the encryption key update timing control unit 111 acquires and stores the system time from the timer unit 15 (step B2). The encryption key update timing control unit 111 then gives the wireless unit 16 an instruction to permit encryption data communication (step B3), and starts monitoring whether or not wireless communication is executed by the wireless unit 16 (step B4).

If no data communication is being executed (NO in step B4), the encryption key update timing control unit 111 checks whether or not the shortest holding time of an encryption key update interval has elapsed (step B5). If the shortest holding time has not elapsed (NO in step B5), the flow returns to step B4 to check whether or not data communication is being executed. If the shortest holding time has elapsed while no data communication is being executed (YES in step B5), the encryption key update timing control unit 111 gives the wireless unit 16 an instruction to inhibit encryption data communication at this point of time (step B6) to stop encryption data communication. The flow then returns to step B1 to cause the encryption key creating unit 112 to create an encryption key.

If data communication is being executed (YES in step B4), the encryption key update timing control unit 111 checks whether or not the longest holding time of an encryption key update interval has elapsed (step B7). If the longest holding time has not elapsed (NO in step B7), the flow returns to step B4 to check whether or not data communication is being executed. If the longest holding time has elapsed while this data communication is being executed (YES in step B7), the encryption key update timing control unit 111 gives the wireless unit 16 an instruction to inhibit encryption data communication at this point of time (step B6) to stop encryption data communication. The flow then returns to step B1 to cause the encryption key creating unit 112 to create an encryption key by 4 way handshake (and group key handshake).

Executing the above control makes it possible to reduce the occurrence of encryption key updating during data communication while maintaining necessary safety. In addition, setting the longest holding time can inhibit unnecessary encryption key updating while no data communication is performed.

(Second Embodiment)

The second embodiment of the present invention will be described next.

In the wireless LAN communication system of the first embodiment described above, the personal computer 1 has the initiative of encryption key updating controls encryption key update timings on the basis of the shortest holding time and longest holding time. In contrast to this, a wireless LAN system according to the second embodiment controls encryption key update timings by using a reference interval time for the determination of whether or not encryption data communication has ceased for a predetermined period of time or more, in place of the shortest holding time. In this wireless LAN communication system, it is determined that encryption data communication which has occurred after the lapse of the reference interval time or more is new data communication, and the encryption key is updated at the start of the data communication. This reference interval time is also data to be set by a user through the GUI provided by a control unit 11 or the like and stored in a data storage unit 14. An encryption key update timing control unit 111 acquires this data at the time of startup or the like.

FIGS. 6A and 6B are charts for explaining the encryption key update timing selection principle of the encryption key update timing control unit 111 according to the second embodiment.

Assume that after given encryption data communication is complete, encryption data communication ceases for a long period of time. In this case, according to the first embodiment, as shown in FIG. 6A, the encryption key creating unit 112 repeatedly creates/updates an encryption key every time the shortest holding time elapses ((2), (2)′, (2)″, . . . in FIG. 6A). Since these encryption keys have never been used, there is no possibility that the keys have been stolen. That is, encryption keys are unnecessarily updated.

In the second embodiment, therefore, if encryption data communication ceases for the reference interval time after given encryption data is complete ((2) in FIG. 6B), the start of next encryption data communication is monitored. If the start of encryption data communication is detected ((3) in FIG. 6B), the encryption key creating unit 112 is caused to create/update an encryption key at this timing.

That is, in the second embodiment, an encryption key is not updated unnecessarily as in the case indicated by (2), (2)′, and (2)″ in FIG. 6A. In addition, updating an encryption key at the start of new encryption data communication makes it possible to reduce the accidental occurrence of encryption key updating as in a case wherein the shortest holding time has elapsed immediately after the start of new encryption data communication, and the longest holding time has then elapsed in this state, i.e., the occurrence of encryption key updating during encryption data communication like that indicated by (1) in FIG. 6A.

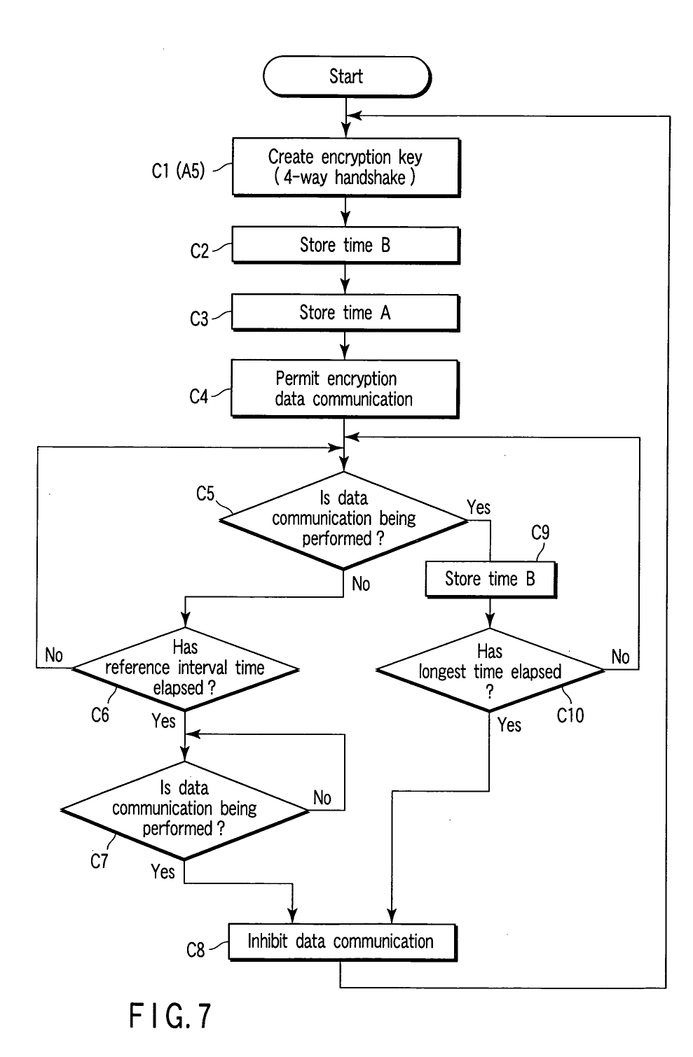

FIG. 7 is a flowchart showing the flow of encryption key update timing control performed by the personal computer 1 according to the second embodiment.

Upon causing the encryption key creating unit 112 to create an encryption key (step C1), the encryption key update timing control unit 111 acquires and stores the system time (time B) from a timer unit 15 (step C2). Acquiring the time B in this case is equivalent to clearing a start point for the calculation of a period of time during which data communication ceases. At this time, the encryption key update timing control unit 111 stores the acquired system time as the time (time A) at which the encryption key was created (step C3). The encryption key update timing control unit 111 then gives a wireless unit 16 an instruction to permit encryption data communication (step C4), and starts monitoring whether or not wireless communication is executed by the wireless unit 16 (step C5).

If no data communication is being executed (NO in step C5), the encryption key update timing control unit 111 checks whether or not the time B, i.e., the elapsed time since the last data communication, has reached the reference interval time (step C6). If the time B has not reached the reference interval time (NO in step C6), the flow returns to step C5 to check whether or not data communication is being executed. If the elapsed time has reached the reference interval time (YES in step C6), the encryption key update timing control unit 111 starts monitoring the execution/non execution of wireless communication by the wireless unit 16 to detect whether or not wireless communication is started by the wireless unit 16 (step C7). If wireless communication is started by the driving circuit 6 (YES in step C7), the encryption key update timing control unit 111 gives the wireless unit 16 an instruction to inhibit encryption data communication at this point of time (step C8) to stop the encryption data communication. The flow then returns to step C1 to cause the encryption key creating unit 112 to create an encryption key by 4 way handshake (and group key handshake). In this case, although the start of data communication is delayed because the data communication is stopped before the start of the data communication, no data interruption occurs.

If data communication is being executed (YES in step C5), the encryption key update timing control unit 111 acquires and stores the system time (time B) from the timer unit 15 again (step C9). The encryption key update timing control unit 111 then checks whether or not the longest holding time of an encryption key update interval has elapsed (step C10). If the longest holding time has not elapsed (NO in step C10), the flow returns to step C5 to check whether or not data communication is being executed. If the longest holding time has elapsed at the time of execution of data communication (YES in step C9), the encryption key update timing control unit 111 gives the wireless unit 16 an instruction to inhibit encryption data communication (step C8) to stop the encryption data communication. The flow then returns to step C1 to cause the encryption key creating unit 112 to create an encryption key by 4 way handshake (and group key handshake).

With the above control, since the continuous communication time from the start of data communication directly becomes the maximum update interval for an encryption key, the probability of executing encryption key updating during data communication can be further reduced while safety is maintained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus comprising:
a data communication unit;
an encryption key creating unit configured to create an encryption key used for encryption of data to be transmitted by the data communication unit;
a monitoring unit configured to monitor a data communication state of the data communication unit;
a time calculating unit configured to calculate an elapsed time since an encryption key is created by the encryption key creating unit; and
an encryption key updating control unit configured to cause the encryption key creating unit to create a new encryption key at a timing at which a state in which no data communication is being executed is detected by the monitoring unit after the elapsed time calculated by the time calculating unit reaches a predetermined shortest holding time.

2. The electronic apparatus according to claim 1, wherein the encryption key updating control unit causes the encryption key creating unit to create a new encryption key at a timing at which the time calculated by the time calculating unit has reached a predetermined longest holding time while a state in which no data communication is being executed is not detected by the monitoring unit.

3. The electronic apparatus according to claim 2, wherein the encryption key updating control unit causes the data communication unit to interrupt data communication when the encryption key creating unit is caused to create a new encryption key at a timing at which the time has reached longest holding time.

4. The electronic apparatus according to claim 1, wherein the data communication unit executes wireless communication complying with IEEE802.11i protocol, and the encryption key creating unit creates the encryption key by executing 4 way handshake processing.

5. The electronic apparatus according to claim 2, further comprising:
a storage unit configured to store the shortest holding time and the longest holding time; and
a setting unit configured to set the shortest holding time and the longest holding time stored in the storage unit.

6. An electronic apparatus comprising:
a data communication unit;
an encryption key creating unit configured to create an encryption key used for encryption of data to be transmitted by the data communication unit;
a monitoring unit configured to monitor a data communication state of the data communication unit;
a first time calculating unit configured to calculate an elapsed time of a state in which after an end of data communication is detected by the monitoring unit, a start of next data communication is not detected; and
an encryption key updating control unit configured to cause the encryption key creating unit to create a new encryption key at a timing at which the start of data communication is detected by the monitoring unit after the elapsed time calculated by the first time calculating unit has reached a predetermined reference interval time.

7. The electronic apparatus according to claim 6, further comprising a second time calculating unit configured to calculate an elapsed time since an encryption key is created by the encryption key creating unit, and
the encryption key updating control unit causes the encryption key creating unit to create a new encryption key at a timing at which an elapsed time calculated by the second time calculating unit has reached a predetermined encryption key holding time while a state in which data communication is being executed is detected by the monitoring unit.

8. The electronic apparatus according to claim 7, wherein the encryption key updating control unit causes the data communication unit to interrupt data communication when the encryption key creating unit is caused to create a new encryption key at a timing at which the elapsed time has reached the encryption key holding time.

9. The electronic apparatus according to claim 6, wherein the data communication unit executes wireless communication complying with IEEE802.11i protocol, and the encryption key creating unit creates the encryption key by executing 4 way handshake processing.

10. The electronic apparatus according to claim 7, further comprising:
a storage unit configured to store the reference interval time and the encryption key holding time; and
a setting unit configured to set the reference interval time and the encryption key holding time stored in the storage unit.

11. An encryption key updating control method for an electronic apparatus having a data communication unit and an encryption key creating unit configured to create an encryption key used for encryption of data to be transmitted by the data communication unit, the method comprising:
monitoring a data communication state of the data communication unit;
calculating an elapsed time since an encryption key is created by the encryption key creating unit; and
causing the encryption key creating unit to create a new encryption key at a timing at which a state in which no data communication is being executed is detected after the calculated elapsed time reaches a predetermined shortest holding time.

12. The encryption key updating control method according to claim 11, further comprising causing the encryption key creating unit to create a new encryption key at a timing at which the calculated elapsed time has reached a predetermined longest holding time while a state in which no data communication is being executed is not detected.

13. An encryption key updating control method for an electronic apparatus having a data communication unit and an encryption key creating unit configured to create an encryption key used for encryption of data to be transmitted by the data communication unit, the method comprising:
monitoring a data communication state of the data communication unit;
calculating a first elapsed time of a state in which after an end of data communication is detected, a start of next data communication is not detected; and
causing the encryption key creating unit to create a new encryption key at a timing at which the start of data communication is detected after the calculated first elapsed time has reached a predetermined reference interval time.

14. The encryption key updating control method according to claim 13, further comprising:
calculating a second elapsed time since an encryption key is created by the encryption key creating unit; and
causing the encryption key creating unit to create a new encryption key at a timing at which the second elapsed time has reached a predetermined encryption key holding time while a state in which data communication is being executed is detected.
